(19) United States
(12) Patent Application Publication
(10) Pub. No.: US 2005/0289570 A1
(43) Pub. Date: Dec. 29, 2005

(54) Load/eject mechanism

(75) Inventors: Nana Birgitta Jernstrom, Brighton (AU); Arjun Caprihan, St. Helena (AU)

Correspondence Address: ROBERT E. KREBS;THELEN REID & PRIEST, LLP, P.O. BOX 640640, SAN JOSE, CA, 95164-0640, US

(73) Assignee: Opdicom Pty. Ltd., an Australian Corporation

(21) Appl. No.: 10/875,674

(22) Filed: Jun. 23, 2004

(51) Int. Cl. B65H 35/08; G11B 17/04

(52) U.S. Cl. 720/624

(57) ABSTRACT

A solution is provided for a load and eject device having a first roller, and a second roller, the first and second roller each having a first end, a second end, and a center, wherein the diameter of the first roller center is smaller than the diameter of the first roller first end and the diameter of the first roller second end. Additionally, the diameter of the second roller center is smaller than the diameter of the second roller first end and the diameter of the second roller second end wherein the first roller and the second roller are designed to receive an optical disk.

### FIELD OF THE INVENTION

The present invention relates to a loading and ejection device. More particularly, the present invention relates to an automatic loading and ejecting device for an optical disk medium.

### BACKGROUND OF THE INVENTION

There are several ways to load and eject an optical disk medium of various kinds such as a compact disk (CD), magneto-optical disk (MOD), digital video disk (DVD), video compact disk (VCD), and the like. A conventional loading device for an optical disk medium has a mechanism to load the media using a saucer-type member, generally called a tray, which extends from the body of the device. After the medium is placed on the tray, the tray is returned to the inside of the device to load data from the optical disk medium. In general, such a conventional loading device cannot be used in an upright position.

Another conventional loading device has a pair of guide members extending from the body of the device to shift the media into or out of the disk slot formed in the body of the device. The guide members have guide grooves for holding the peripheral edge portions of the disk, which is inserted into the grooves. The disk is then carried by the guide members into the device for use. This conventional loading device may be used in an upright position.

Still yet, there are other devices, which do to not require a tray or guide member to extend out from the device. These devices may utilize one or a pair of guide rollers to automatically load and eject the media. With one guide roller, the optical medium is compressed between the guide roller and a stationary low friction surface, such as a pad. The medium is loaded and ejected through movement of the guide roller, in the intended direction of use, with the guide roller in contact with the entire surface of the medium. The use of two guide rollers is similar, however, the medium is ejected and loaded through compression between the guide rollers, which also contacts the entire surface of the medium. Although the use of the guide rollers avoids the use of a tray or guide member extending externally from the device, use of the roller(s) has its own disadvantages. One disadvantage is that it is easy for the rollers or pad to gather abrasive substances such as dirt or debris. Thus, when the medium is ejected or inserted into the device, the rollers come in contact with the entire surface of the medium causing scratches or dents on the medium, which ultimately results in loss of data contained on the optical disk medium. Another disadvantage is that the medium must be positioned in a certain orientation for a reader to obtain data from the medium.

### BRIEF DESCRIPTION OF THE INVENTION

A solution is provided for a load and eject device having a first roller, and a second roller, the first and second roller each having a first end, a second end, and a center, wherein the diameter of the first roller center is smaller than the diameter of the first roller first end and the diameter of the first roller second end. Additionally, the diameter of the second roller center is smaller than the diameter of the second roller first end and the diameter of the second roller second end wherein the first roller and the second roller are designed to receive an optical disk.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIGS. 1A, 1B, 1C illustrate the rollers in accordance with an embodiment of the present invention.

FIG. 2 is a diagram illustrating a perspective view of the ejection/loading device in a chassis in accordance with an embodiment of the present invention.

FIGS. 3A and 3B illustrate the ejection/loading mechanism in use with an optical media storage device in accordance with an embodiment of the present invention.

FIG. 4 is a block diagram illustrating a method of ejecting and/or loading a disk into an optical media storage device in accordance with an embodiment of the present invention.

### DETAILED DESCRIPTION

Embodiments of the present invention are described herein in the context of a load/eject mechanism. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

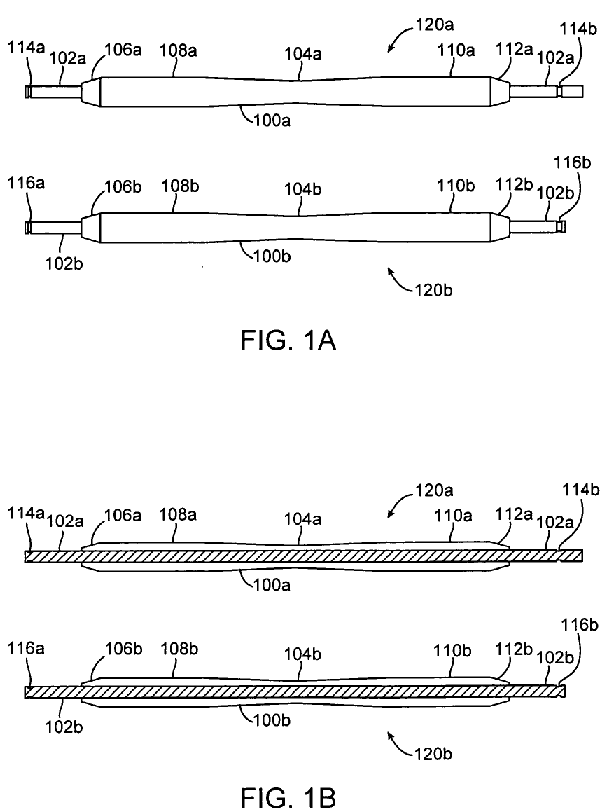

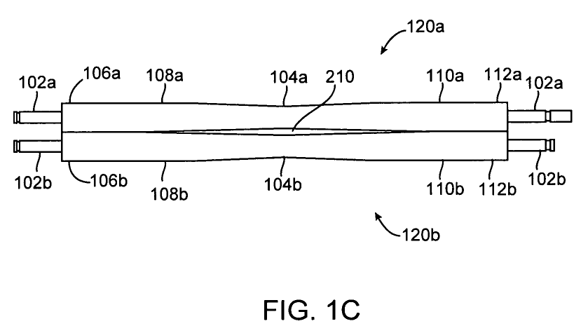

The present invention is an automatic load and eject device for an optical disk medium (herein after referred to as a “disk”). The load and eject device uses a pair of rollers which are tapered in the center to prevent any abrasives from contacting the data surface of the disk. FIGS. 1A, 1B, and 1C illustrate the rollers in accordance with an embodiment of the present invention. FIG. 1B is a cross sectional view of FIG. 1A. A pair of rollers 120a, 120b each consist of a rubber tube 100a, 100b fitted around a shaft 102a, 102b.

The rubber tubes 100a, 100b may be shaped with several tapered ends. One tapered end starts from the first end 108a, 108b and the second end 110a, 100b toward the center 104a, 104b such that the narrowest part of the tube 100a, 100b is at the center 104a, 104b. Thus, the diameter of first end 108a, 108b and second end 110a, 110b is larger than the diameter of center 104a, 104b. Another taper may be at the tip 106a, 106b of first end 108a, 108b and at the tip 112a, 112b of second end 110a, 110b such that the diameter of tips 106a, 106b, 112a, 112b are smaller in diameter than the first end 108a, 108b and the second end 110a, 110b. However, as illustrated in FIG. 1C, the exact position of where the taper begins may vary. Furthermore, tips 106a, 106b, 112a, and 112b need not be tapered such that the diameter of first end 108a, 108b, second end 110a, 110b, and tips 106a, 106b, 112a, 112b are the same.

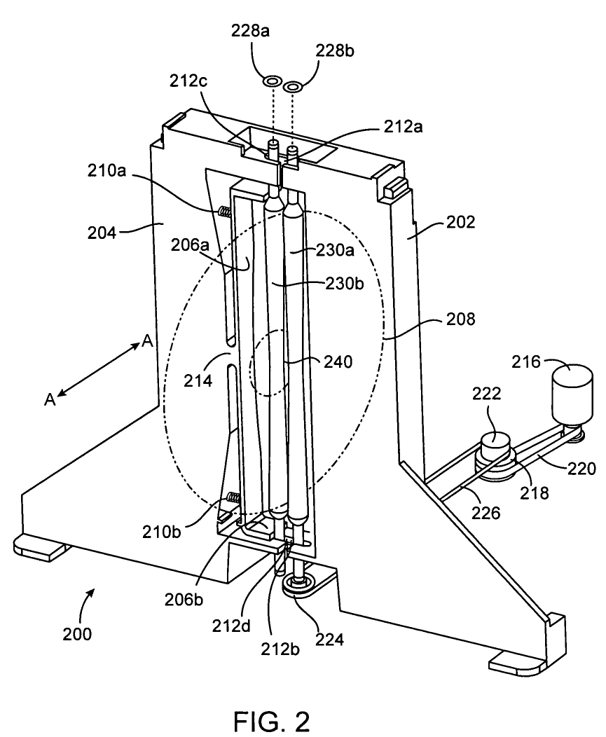

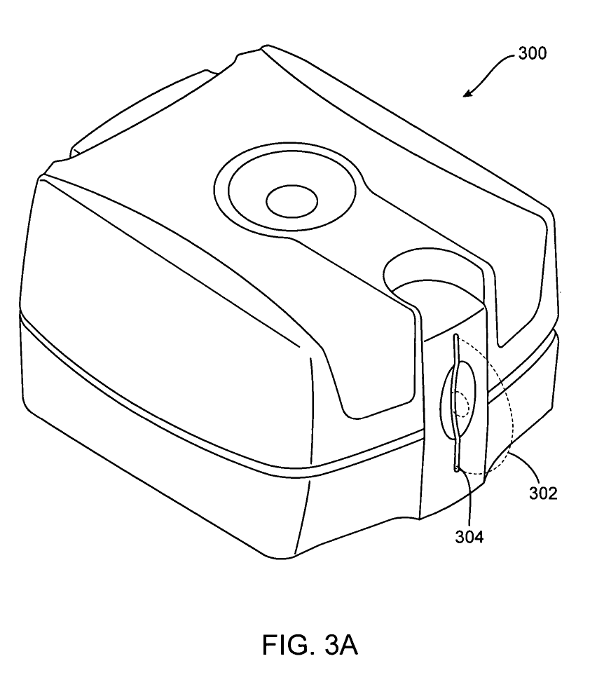

When the rollers 120a, 120b are pressed into gentle contact with each other, the tapering of the rubber tubes 100a, 100b towards the center 104a, 104b forms a narrow diamond shape 240 in the middle of the rollers 120a, 120b. The diamond shape 240 provides a lead in for the disk 208 (shown in FIG. 2) and at the same time allows for minimum contact of the rollers 120a, 120b with the data surface of the disk 208. The disk 208 is held only by its edges as it moves between the rollers 120a, 120b.

As illustrated in FIG. 1B, the shafts 102a, 102b are fitted through the rubber tubes 100a, 100b and are used to support the rubber tubes 100a, 100b in a chassis as further discussed below. Grooves 114a, 114b, 116a, 116b may be used to locate and position the shafts 102a, 102b in the chassis.

The rubber tubes 100a, 100b may be made of any resilient material such as rubber, silicone, plastic, or other synthetic or natural materials with similar properties. By way of example only, the tubes 100a, 100b may be made of silicone with a hardness of between 25-45 shore A. The shafts 102a, 102b may be made of any strong material such as stainless steel, plastic, metal, and the like.

FIG. 2 is a diagram illustrating a perspective view of the ejection/loading device in a chassis in accordance with an embodiment of the present invention. The rollers described above may be used with any optical media loading or ejecting device. However, by way of example only and not intended to be limiting, the rollers 230a, 230b will be described in conjunction with a chassis device, generally numbered 200. The chassis may be any supporting device to securely rotatably hold the rollers in position. However, by way of example only and not intended to be limiting, the chassis will be described with reference to FIG. 2. The chassis 200 has a first support member 202 with slots 212a, 212b to rotatably support the central axis of roller 230a. The chassis 200 also has a second support member 204 with slots 212c, 212d to rotatably support the central axis of roller 230b.

Second support member 204 may have resilient members 206a, 206b attached to second support member 204 at a center 214. Springs 210a, 210b may be positioned between second support member 204 and resilient members 206a, 206b. The pressure created by springs 210a, 210b urge roller 230b toward roller 230a and prevents the rollers 230a, 230b from falling out in normal use or in transport. Alternatively, no springs may be used and resilient members 206a, 206b may be made of stiff resilient material to urge roller 230b, toward roller 230a. Furthermore, the urging of roller 230b toward roller 230a assists in the movement of disk (shown in phantom) 208 in either direction A-A′ during rotation of the rollers 230a, 230b. For additional support, support disks 228a, 228b, 228c may be used and received by grooves 114a, 116a, 116b (FIG. 1A) to prevent rollers 230a, 230b from falling out.

The rollers 230a, 230b are driven for rotation by a roller motor 216, by way of a pulley assembly. Any current pulley assembly may be used. However, by way of example only and not intended to be limiting, the roller motor 216 may be connected to a driving pulley 218 by pulley 220. Driving pulley 218 has a shaft 222, which is connected to a pulley 224 by belt 226. The pulley 224 is fitted to roller 230a. Thus, when the roller motor 216 is activated, roller 230a will rotate.

As described above, roller 230a is driven by a roller motor 216. However, roller 230b is not driven and is free to move against the disk 208 as it shifts in and out of the chassis 200. Thus, contrary to a stationary pad used in current devices, there is no relative motion of the disk 208 surface against roller 230b, thus preventing any possible abrasion or damage to the disk 208 surface.

The chassis 200 and support disks 228a, 228b may be made of any sturdy material such as plastic, steel, metal, or any other similar materials. However, to reduce cost and aid in assembly, plastic should be used. The springs 210a, 210b may be made of any resilient, sturdy material that is able to regain its original shape such as metal, plastic, rubber, silicone, spring steel, and the like.

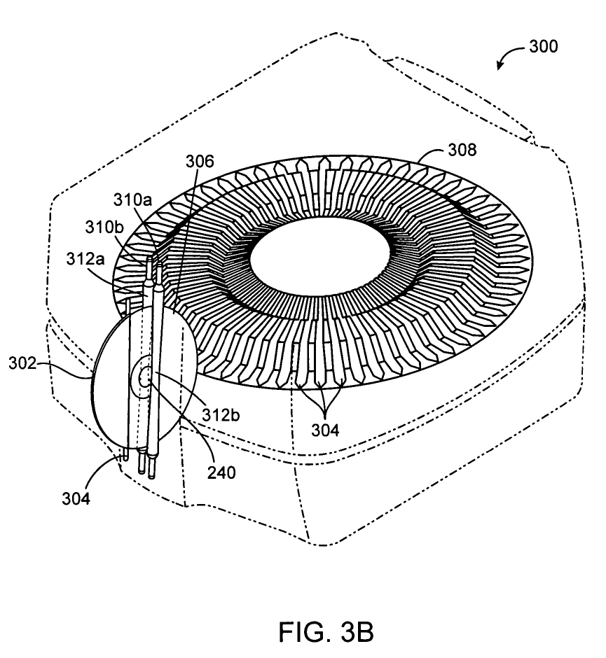

FIGS. 3A and 3B illustrate the ejection/loading mechanism in use with an optical medium storage device in accordance with an embodiment of the present invention. As stated above, the rollers described above may be used with any current optical medium devices such as a compact disc player, a DVD play, and the like. However, by way of example only and not intended to be limiting, the rollers 310a, 310b may be used in conjunction with an optical media storage device, generally numbered as 300 as illustrated in FIG. 3A.

Referring now to FIG. 3B, as the disk 302 is inserted into a disk slot 304, it is inserted between rollers 310a, 310b. The rollers 310a, 310b may be rotatably supported by the chassis as illustrated in FIG. 2, but is not illustrated in FIG. 3B to prevent over complication or confusion of the figure. The disk causes the rollers 310a, 310b to separate by a distance equivalent to the thickness of the disk 302.

The detection of the disk 302 entering or exiting the disk slot may be achieved by any manner. However, for exemplary purposes only and not intended to be limiting, opto-interrpter devices (not shown) may be used to detect the disk 302 as the disk 302 enters or exits the disk slot 304. An opto-interrpter may be positioned in front of the rollers 310a, 310b and an opto-interrpter may be positioned behind the rollers 310a, 310b. As the disk 302 enters the disk slot 304, an output from the front opto-interrpter causes the roller motor to start which starts the movement of the rollers 310a, 310b. Once the disk 302 clears the rollers 310a, 310b an output from the opto-interrpter behind the rollers turns the roller motor off.

When the disk 302 is ejected out of the disk slot, the opposite occurs. An output from the opto-interrupter behind the rollers starts the roller motor which in turn causes the rollers 310a, 310b to turn. Another output from the front opto-interrupter, which detects the disk in the fully ejected position (but still positioned between the rollers so that the disk does not fall out), signals the roller motor to turn off.

As the rollers 310a, 310b rotate, the narrow diamond 240 shape formed by the tapering of tubes 312a, 312b provides for a lead in for the disk 302 and at the same time allows for minimum contact of the rollers 310a, 310b with the data surface of the disk 302. As illustrated in FIGS. 2 and 3B, any diameter-sized optical disk media may be used. The disk 302 is held only by its edges 306 as it moves between the rollers 310a, 310b. This prevents any possible abrasion or damage to the data surface of the disk 302. To further prevent damage to the data surface of the disk 302, roller 310b freely rotates against the disk as it is loaded into the storage device 300.

As the disk 302 is loaded into the device, it is guided into the appropriate storage slot 304 in the storage carousel 308. When the disk 302 is ejected from the storage device 300, the method above is followed, but in reverse order.

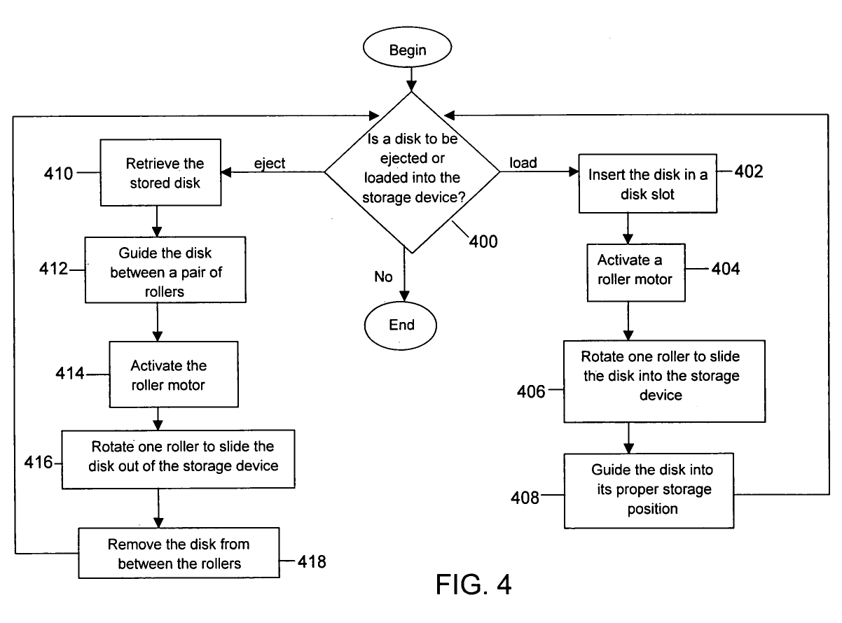

A method of using the rollers and chassis in an optical media storage device is also provided. FIG. 4 is a block diagram illustrating a method of ejecting and/or loading a disk into an optical medium storage device in accordance with an embodiment of the present invention. If a disk is to be loaded at 400, the disk is inserted in a disk slot at 402 and between a pair of rollers. Disk entry is detected by an opto-interrupter to activate a roller motor at 404, which rotates one roller to drive the disk into the storage device at 406. The disk is guided into the proper storage position in the storage device at 408.

If the disk is to be ejected at 400, the stored disk is retrieved from its stored position at 410 and guided between the pair of rollers at 412. The disk may be retrieved by any means known in the art and will not be discussed herein to not complicate the present invention. An opto-interrupter detects the disk which activates the roller motor at 414, to rotate one roller to drive the disk out of the storage device at 416. The disk is then removed from between the rollers at 418.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A load and eject device for an optical disk, comprising:
a first roller and a second roller, the first and second roller each having a first end, a second end, and a center;
wherein a diameter of the first roller center is smaller than a diameter of the first roller first end and a diameter of the first roller second end; wherein a diameter of the second roller center is smaller than a diameter of the second roller first end and a diameter of the second roller second end; and wherein the first roller and the second roller are designed to receive an optical disk.

2. The device of claim 1 wherein the first roller further comprise a first end tip and a second end tip, wherein a diameter of the first end tip is smaller than the diameter of the first roller first end and a diameter of the second end tip is smaller than the diameter of the first roller second end.

3. The device of claim 1 wherein the second roller further comprise a first end tip and a second end tip, wherein a diameter of the first end tip is smaller than the diameter of the second roller first end and a diameter of the second end tip is smaller than the diameter of the second roller second end.

4. The device of claim 1 wherein the first roller and the second roller are made of a resilient material.

5. The device of claim 4 wherein the resilient material is silicone.

6. The device of claim 4 wherein the resilient material is rubber.

7. The device of claim 1 wherein the first roller has a lumen to receive a shaft.

8. The device of claim 1 wherein the second roller has a lumen to receive a shaft.

9. The device of claim 1 further comprising a spring to urge the first roller against the second roller.

10. The device of claim 1 wherein the first roller and the second roller form an opening at the center wherein the first and second rollers contact the optical disk at an outer edge of the optical disk.

11. A load and eject device for an optical disk, comprising:
a first tube and a second tube, the first and second tube each having a lumen, a first end, a second end, and a center;
a first shaft received by the first tube lumen; and
a second shaft received by the second tube lumen;
wherein the first and second tubes each have a center diameter smaller than a diameter of the first end and a diameter of the second end; and wherein the first tube and the second tube are designed to receive the optical disk.

12. The device of claim 11 wherein the first tube further comprises a first end tip and a second end tip, wherein a diameter of the first end tip is smaller than the diameter of the first tube first end and a diameter of the second end tip is smaller than the diameter of the first tube second end.

13. The device of claim 11 wherein the second tube further comprises a first end tip and a second end tip, wherein a diameter of the first end tip is smaller than the diameter of the second tube first end and a diameter of the second end tip is smaller than the diameter of the second tube second end.

14. The device of claim 11 wherein the first tube and the second tube are made of a resilient material.

15. The device of claim 14 wherein the resilient material is silicone.

16. The device of claim 14 wherein the resilient material is rubber.

17. The device of claim 11 further comprising a spring to urge the first tube against the second tube.

18. The device of claim 11 wherein the first tube and the second tube form an opening at the center wherein the first and second tubes contact the optical disk at an outer edge of the optical disk.

19. The device of claim 11 further comprising a chassis having:
a first support member having a first slot and a second slot to receive the first shaft; and
a second support member opposite the first support member, the second support member having a third slot and a fourth slot to receive the second shaft.

20. The device of claim 11 further comprising a pulley device coupled to the first shaft at a first shaft bottom end, wherein the pulley device is coupled to a roller motor to rotate the first shaft.

21. An optical medium storage device, comprising:
a storage body;
a disk slot formed in the storage body for receiving an optical media;
a chassis disposed proximate to the disk slot; and
a first roller and a second roller, the first and second roller rotatably mounted on the chassis to securely shift the optical media in or out of the storage device, the first and second roller each having a tube with a lumen to receive a shaft, the first and second roller each having a first end and a second end;
wherein the first roller and the second roller are each tapered at a center to form an opening at the center when the first roller is urged toward the second roller such that the first and second tubes contact the optical media at an outer edge of the optical media.

22. The optical media storage device of claim 21 wherein the first roller further comprises a first end, a second end, a first end tip, and a second end tip, wherein a diameter of the first end tip is smaller than a diameter of the first end and a diameter of a second end tip is smaller than a diameter of the second end.

23. The device of claim 21 wherein the second roller further comprises a first end, a second end, a first end tip and a second end tip, wherein a diameter of the first end tip is smaller than a diameter of the first end and a diameter of the second end tip is smaller than a diameter of the second end.

24. The device of claim 21 wherein the first roller and the second roller are made of a resilient material.

25. The device of claim 24 wherein the resilient material is silicone.

26. The device of claim 24 wherein the resilient material is rubber.

27. The device of claim 21 further comprising at least one spring to urge the first roller against the second roller.

28. The device of claim 21 wherein the chassis further comprises:
a first support member having a first slot and a second slot to receive the first roller; and
a second support member opposite the first support member, the second support member having a third slot and fourth slot to receive the second roller.

29. The device of claim 21 further comprising a pulley device coupled to the first roller at a first roller bottom end, wherein the pulley device is coupled to a roller motor to rotate the first roller.

30. The device of claim 21 further comprising a storage carousel disposed proximate the chassis having a storage slot to receive the optical medium.

31. A method for loading an optical disk into an optical disk storage device, comprising:
inserting an optical disk into a disk slot;
activating a roller motor;
rotating at least one roller;
sliding the disk between a first roller and a second roller, the first roller and second roller designed to receive the optical disk; and
contacting the optical disk at an outer edge of the optical disk.

32. The method of claim 31 further comprising urging the first roller toward the second roller.

33. The method of claim 31 wherein the first roller and the second roller each further comprise a taper at a center to form an opening at the center to contact the optical disk at an outer edge of the optical disk.

34. A apparatus for loading an optical disk into an optical disk storage device, comprising:
means for inserting an optical disk into a disk slot;
means for activating a roller motor;
means for rotating at least one roller;
means for sliding the disk between a first roller and a second roller, the first roller and second roller designed to receive the optical disk; and
means for contacting the optical disk at an outer edge of the optical disk.

35. The apparatus of claim 34 further comprising means for urging the first roller toward the second roller.

36. The apparatus of claim 34 wherein the first roller and the second roller each further comprise a taper at a center to form an opening at the center to contact the optical disk at an outer edge of the optical disk.

37. A method for ejecting an optical disk from an optical disk storage device, comprising:
retrieving the optical disk from a storage position;
guiding the optical disk between a pair of rollers;
activating a roller motor;
rotating at least one roller;
sliding the optical disk out of the optical disk storage device; and
contacting the optical disk at an outer edge of the optical disk.

38. The method of claim 37 further comprising urging the first roller toward the second roller.

39. The method of claim 37 wherein the first roller and the second roller each further comprise a taper at a center to form an opening at the center to contact the optical disk at an outer edge of the optical disk.

40. A apparatus for ejecting an optical disk from an optical disk storage device, comprising:
means for retrieving the optical disk from a storage position;
means for guiding the optical disk between a pair of rollers;
means for activating a roller motor;
means for rotating at least one motor;
means for sliding the optical disk out of the optical disk storage device; and
means for contacting the optical disk at an outer edge of the optical disk.

41. The apparatus of claim 40 further comprising means for urging the first roller toward the second roller.

42. The apparatus of claim 40 wherein the first roller and the second roller each further comprise a taper at a center to form an opening at the center to contact the optical disk at an outer edge of the optical disk.
